(19) United States
(12) Patent Application Publication
(10) Pub. No.: US 2012/0131892 A1
(43) Pub. Date: May 31, 2012

(54) DETACHABLE AIR FILTER MACHINE

(75) Inventor: Mao-Nan Cheng, Fongyuan City (TW)

(73) Assignee: SAN FORD MACHINERY CO., LTD., Fongyuan City (TW)

(21) Appl. No.: 12/955,913

(22) Filed: Nov. 30, 2010

(51) Int. Cl. B01D 46/00

(52) U.S. Cl. 55/476

(57) ABSTRACT

A detachable air filter machine includes a base, at least one lower filter seat, a machine frame, at least one upper filter seat, an upper lid and two pressure cylinders which are stacked in sequence from bottom to top. The base includes a pair of limit members at two opposing sides thereof. The pair of limit members each is pivotally connected with a buckling member. The upper lid has a buckling portion corresponding to the buckling member for engagement of the buckling member. The user can pull the buckling member to take off the upper and lower filter seats for cleaning. The detachable air filter machine is simple in structure and can be assembled and disassembled quickly for maintenance to save time and effort.

### BACKGROUND OF THE INVENTION

1. Field of the Invention

The present invention relates to a detachable air filter machine.

2. Description of the Prior Art

In order to improve the environment quality, people use an air filter machine to filter and purify the surroundings air. A conventional air filter machine comprises a main body. The main body has a chamber therein. The surface of the main body has a plurality of inlets and outlets which communicate with the chamber. An air blower and a plurality of filters are provided in the chamber of the main body. The air blower inhales the surroundings air to the chamber through the inlets. The air is filtered through the filters and then expelled through the outlets. However, the filters may be blocked after a period of time. It is required to clean or replace the filters. The filters of the conventional air filter machine are direct mounted in the main body. It is necessary to first disassemble the main body and then to clean or replace the filters. This way is time-consuming. Particularly, the air blower has a certain weight, which is not easy to disassemble. Accordingly, the inventor of the present invention has devoted himself based on his many years of practical experiences to solve this problem.

### SUMMARY OF THE INVENTION

The primary object of the present invention is to provide a detachable air filter machine. The detachable air filter machine comprises a base. The base includes a pair of limit members at two opposing sides thereof. The pair of limit members each is pivotally connected with a buckling member. The base has a plurality of air inlets thereon. The detachable air filter machine further comprises at least one lower filter seat. The lower filter seat is stacked on top of the base and located between the pair of limit members. The lower filter seat has a trough at a top end thereof to receive a first filter. The lower filter seat has a plurality of through holes at a bottom end thereof. The through holes communicate with the air inlets. The detachable air filter machine further comprises a machine frame stacked on top of the lower filter seat. The machine frame has an accommodation room therein. The machine frame further has upper and lower openings at upper and lower ends thereof to communicate with the accommodation room. The accommodation room communicates with the trough of the lower filter seat. The machine frame further comprises an air blower in the accommodation room. The detachable air filter machine further comprises at least one upper filter seat stacked on top of the machine frame. The upper filter seat has a receiving trough at a top end thereof to receive a second filter. The upper filter seat has a plurality of holes at a bottom end thereof to communicate with the receiving trough. The holes of the upper filter seat communicate with the machine frame. The detachable air filter machine further comprises an upper lid disposed on the upper filter seat. The upper lid has a buckling portion at a top end thereof corresponding to the buckling member for engagement of the buckling member. The upper lid has a plurality of outlets thereon. The outlets communicate with the receiving trough of the upper filter seat. The detachable air filter machine further comprises two pressure cylinders disposed between each limit member and the machine frame. One end of each pressure cylinder is connected to the corresponding limit member and another end of each pressure cylinder is connected to the machine frame. The pressure cylinders provide a force to the machine frame to be moved upward. Accordingly, the detachable air filter machine of the present invention is simple in structure and can be assembled and disassembled quickly for maintenance to save time and effort. Furthermore, the pressure cylinders can assist the user in lifting the machine frame to separate the machine frame from the lower filter seat for the user to clean or replace the first filter in the lower filter seat.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a partially enlarged view according to the preferred embodiment of the present invention;

FIG. 4 is an exploded view showing an upper filter seat according to the preferred embodiment of the present invention; and

FIG. 5 is a schematic view when in use according to the preferred embodiment of the present invention.

### DETAILED DESCRIPTION OF THE PREFERRED EMBODIMENTS

Embodiments of the present invention will now be described, by way of example only, with reference to the accompanying drawings.

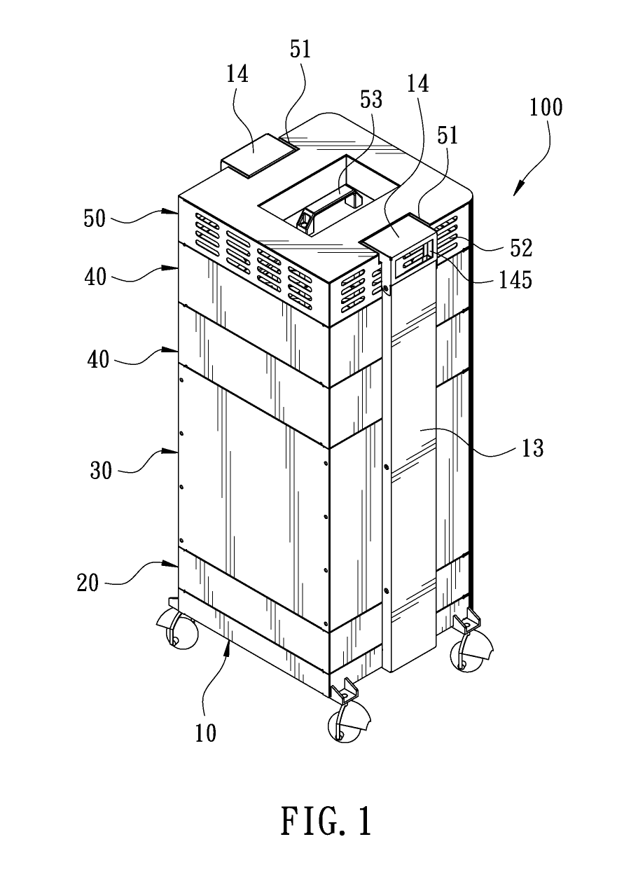

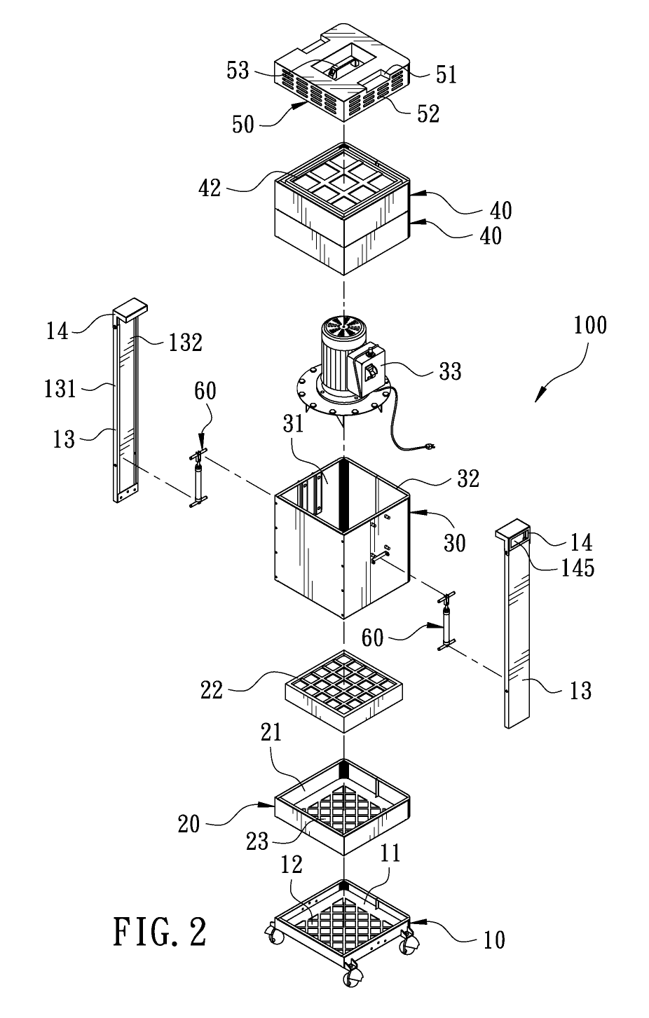

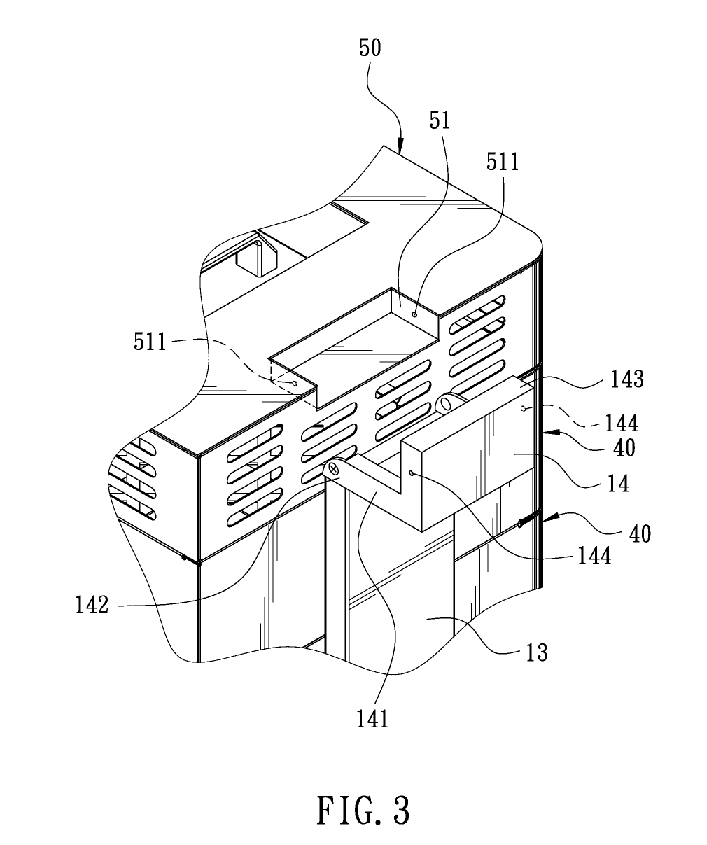

As shown in FIG. 1 to FIG. 4, a detachable air filter machine 100 according to a preferred embodiment of the present invention comprises a base 10, at least one lower filter seat 20, a machine frame 30, at least one upper filter seat 40, an upper lid 50, and two pressure cylinders 60.

The base 10 has a coupling trough 11 at a top end thereof and a plurality of air inlets 12 at a bottom end thereof. The air inlets 12 communicate with the coupling trough 11. The base 10 has two opposing sides connected with a pair of limit members 13. Each limit member 13 has a rectangular body 131. The body 131 has a chamber 132 facing the side of the machine frame 30. The base 10 further comprises a buckling member 14 which is pivotally connected with each of the pair of limit member 13. The buckling member 14 has an L-shaped main body 141. The main body 141 has two ends to define a pivot end 142 and a buckling end 143. The pivot end 142 is pivotally connected to a free end of the limit member 13. The buckling end 143 is used to engage with a buckling portion 51 of the upper lid 50. The buckling member 14 has a pair of positioning concaves 144 at two sides of the buckling end 143. Furthermore, the buckling member 14 has an opening 145 at one side of the main body 141.

The lower filter seat 20 is stacked on top of the base 10 and located between the pair of limit members 13. The lower filter seat 20 has a trough 21 at a top end thereof to receive a first filter 22. The first filter 22 can be a metal filter net. The lower filter seat 20 has a plurality of through holes 23 at a bottom end thereof. The through holes 23 communicate with the air inlets 12. In this embodiment, the detachable air filter machine 100 has one lower filter seat 20.

The machine frame 30 is stacked on top of the lower filter seat 20. The machine frame 30 has an accommodation room 31 therein. The machine frame 30 further has upper and lower openings 32 at upper and lower ends thereof to communicate with the accommodation room 31, so that the accommodation room 31 communicates with the trough 21 of the lower filter seat 20. The machine frame 30 further comprises an air blower 33 in the accommodation room 31.

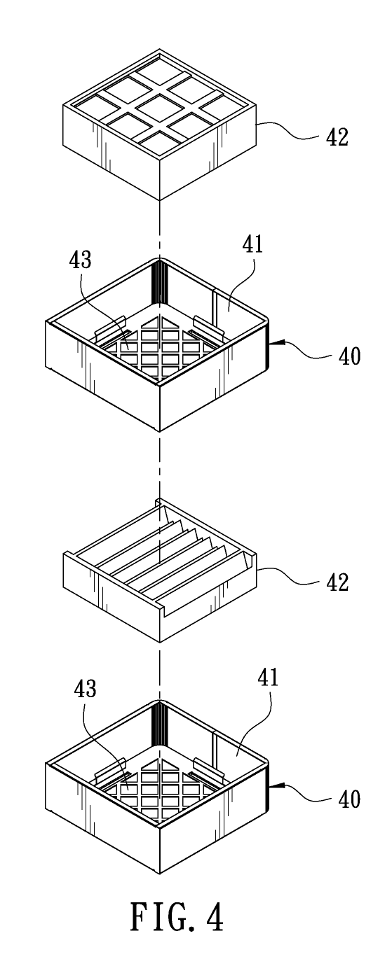

The upper filter seat 40 is stacked on top of the machine frame 30. Referring to FIG. 4, in this embodiment the detachable air filter machine 100 comprises two upper filter seats 40. The upper filter seat 40 has a receiving trough 41 at a top end thereof to receive a second filter 22. The second filter 42 can be active carbon or a high efficiency particulate air filter (HEPA). The upper filter seat 40 has a plurality of holes 43 at a bottom end thereof. The holes 43 communicate with the receiving trough 41. The hole 43 of the lowest upper filter seats 40 communicate with the accommodation room 31 of the machine frame 30.

The upper lid 50 is used to cover the upper filter seat 40. The upper lid 50 has a buckling portion 51 at a top end thereof corresponding to the buckling member 14. The buckling portion 51 is a notch formed on a circumferential edge of the upper lid 50 for engagement of the buckling member 14. The upper lid 50 has a pair of positioning convexes 511 on the buckling portion 51 to engage with the pair of positioning concaves 144. The upper lid 50 has a plurality of outlets 52 around a circumferential wall thereof. The outlets 52 communicate with the receiving trough 41 of the upper filter seat 40. The upper lid 50 further comprises a handle 53 at the top end of the upper lid 50.

The two pressure cylinders 60 are disposed between each limit member 13 and the machine frame 30 and located in the chamber 132 of the limit member 13. One end of the pressure cylinder 60 is connected to the limit member 13 and another end of the pressure cylinder 60 is connected to the machine frame 30, providing a force to the machine frame 30 to be moved upward.

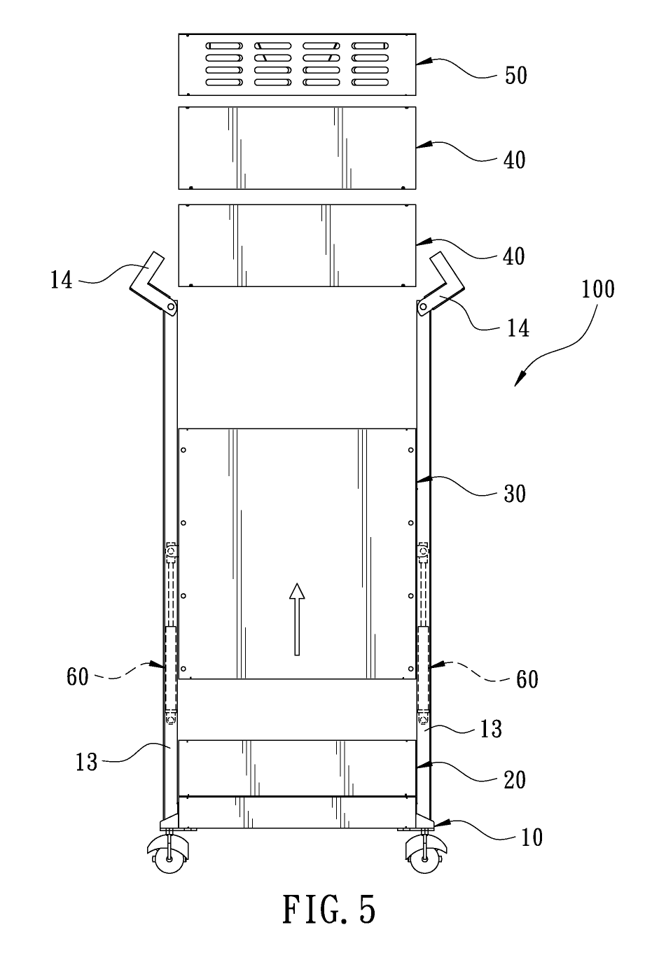

FIG. 5 is a schematic view when in use according to the preferred embodiment of the present invention. When the detachable air filter machine 100 is started, the air blower 33 will inhale the surroundings air from the air inlets 12 into the coupling trough 11. Then, the air enters the trough 21 through the through holes 23 of the lower filter seat 20 and is filtered through the first filter 22. After that, the filtered air passes the machine frame 30 and enters the receiving trough 41 through the holes 43 of the upper filter seat 40 and is filtered again through the second filter 42 to purify the air. Finally, the purified air is expelled through the outlets 52 of the upper lid 50.

When the user wants to clean or replace the first filter 22 and the second filter 42, the buckling member 14 can be disengaged from the buckling portion 51 by pulling the opening 145 of the buckling member 14 and the upper lid 50 can be taken off by holding the handle 53. Because the upper filter seats 40 are direct stacked on the machine frame 30, it is easy for the user to take off the upper filter seats 40 in sequence so as to clean or replace the second filter 42 in the receiving trough 41. Besides, after the user takes off the upper filter seats 40, there will be no load on the machine frame 30. Thus, the pressure cylinders 60 will push the machine frame 30 to move upward to separate the machine frame 30 from the lower filter seat 20. The user can take off the lower filter seat 20 to clean or replace the first filter 22 in the trough 21.

After the first filter 22 and the second filter 42 are cleaned or replaced, the lower filter seat 20 is connected between the base 10 and the machine frame 30 and the upper filter seats 40 are coupled on the machine frame 30 and the upper lid 50 is coupled on top of the upper filter seats 40. At this time, the load on the machine frame 30 is increased and the machine frame 30 will overcome the force from the pressure cylinders 60 to move downward, so the user can buckle the buckling members 14 with ease to complete the assembly of the detachable air filter machine 100.

Accordingly, the detachable air filter machine of the present invention is simple in structure and can be assembled and disassembled quickly for maintenance to save time and effort. Furthermore, the pressure cylinders can assist the user in lifting the machine frame to separate the machine frame from the lower filter seat for the user to clean or replace the first filter in the lower filter seat.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A detachable air filter machine, comprising:
a base including a pair of limit members at two opposing sides thereof, the pair of limit members each being pivotally connected with a buckling member, the base having a plurality of air inlets thereon;
at least one lower filter seat stacked on top of the base and located between the pair of limit members, the lower filter seat having a trough at a top end thereof to receive a first filter, the lower filter seat having a plurality of through holes at a bottom end thereof, the through holes communicating with the air inlets;
a machine frame stacked on top of the lower filter seat, the machine frame having an accommodation room therein, the machine frame further having upper and lower openings at upper and lower ends thereof to communicate with the accommodation room, the accommodation room communicating with the trough of the lower filter seat, the machine frame further comprising an air blower in the accommodation room;
at least one upper filter seat stacked on top of the machine frame, the upper filter seat having a receiving trough at a top end thereof to receive a second filter, the upper filter seat having a plurality of holes at a bottom end thereof to communicate with the receiving trough, the holes of the upper filter seat communicating with the machine frame;
an upper lid disposed on the upper filter seat, the upper lid having a buckling portion at a top end thereof corresponding to the buckling member for engagement of the buckling member, the upper lid having a plurality of outlets thereon, the outlets communicating with the receiving trough of the upper filter seat; and
two pressure cylinders disposed between each limit member and the machine frame, one end of each pressure cylinder being connected to the corresponding limit member and another end of each pressure cylinder being connected to the machine frame, the pressure cylinders providing a force to the machine frame to be moved upward.

2. The detachable air filter machine as claimed in claim 1, wherein each limit member has a rectangular body, and the body has a chamber facing the machine frame to accommodate the pressure cylinders.

3. The detachable air filter machine as claimed in claim 1, wherein the buckling portion is a notch formed on a circumferential edge of the upper lid, the buckling member has an L-shaped main body, the main body has two ends to define a pivot end and a buckling end, the pivot end is pivotally connected to the corresponding limit member, and the buckling end is used to engage with the buckling portion of the upper lid.

4. The detachable air filter machine as claimed in claim 3, wherein the buckling member has a pair of positioning concaves at two sides of the buckling end, and the upper lid has a pair of positioning convexes on the buckling portion to engage with the pair of positioning concaves.

5. The detachable air filter machine as claimed in claim 1, wherein the buckling member has an opening at one side thereon.

6. The detachable air filter machine as claimed in claim 1, wherein the first filter is a metal filter net.

7. The detachable air filter machine as claimed in claim 1, wherein the second filter is active carbon.

8. The detachable air filter machine as claimed in claim 1, the second filter is a high efficiency particulate air filter (HEPA).
